(19) United States
(12) Patent Application Publication
(10) Pub. No.: US 2006/0143245 A1
(43) Pub. Date: Jun. 29, 2006

(54) Low overhead mechanism for offloading copy operations

(76) Inventors: Ravishankar Iyer, Hillsboro, OR (US); Srihari Makineni, Portland, OR (US); Ramesh Illikkal, Portland, OR (US); Donald Newell, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/026,321

(22) Filed: Dec. 29, 2004

(51) Int. Cl. G06F 17/30

(52) U.S. Cl. 707/204

(57) ABSTRACT

In some embodiments, a low overhead mechanism for offloading copy operations is presented. In this regard, a copy agent is introduced to receive a copy request, to notify of copy completion before the copy has been performed, and to perform the copy. Other embodiments are also disclosed and claimed.

### FIELD OF THE INVENTION

Embodiments of the present invention generally relate to the field of data transfer, and, more particularly to a low overhead mechanism for offloading copy operations.

### BACKGROUND OF THE INVENTION

Applications move or copy data from one memory location (address) to another. Typically, the data movement or copy operations are performed by the CPU. However, since the CPU typically has to fetch the data from memory (which is much slower), the copy operation tends to be rather slow. To speed up the copy operation and avoid stalling the CPU, some systems employ copy engines. The main overhead in dealing with copy engines is the setup and notification overhead. The CPU typically initiates the operation of the DMA engine and continues performing other work. Completion notification is provided using traditional mechanisms such as polling or interrupts. Both polling and interrupts can be a source of inefficiency since the processor is occupied during the process.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing control and copy agents, in accordance with one example embodiment of the invention;

FIG. 2 is a block diagram of an example copy agent architecture, in accordance with one example embodiment of the invention;

FIG. 3 is a block diagram of an example control agent architecture, in accordance with one example embodiment of the invention; and

FIG. 4 is a flow chart of an example method for early copy completion, in accordance with one example embodiment of the invention.

### DETAILED DESCRIPTION

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

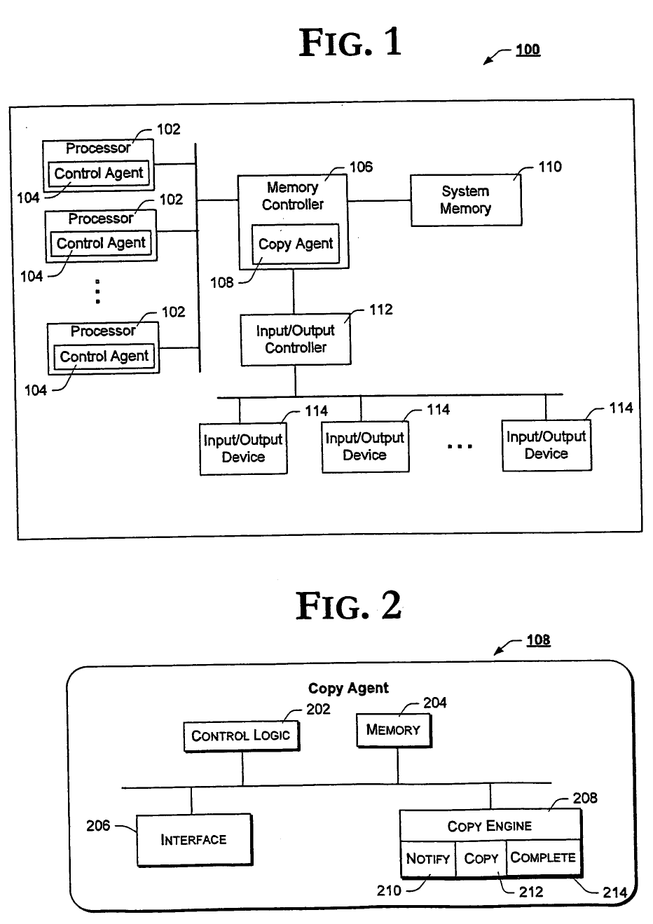

FIG. 1 is a block diagram of an example electronic appliance suitable for implementing control and copy agents, in accordance with one example embodiment of the invention. Electronic appliance 100 is intended to represent any of a wide variety of traditional and non-traditional electronic appliances, laptops, desktops, servers, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, control agent(s) 104, memory controller 106, copy agent 108, system memory 110, input/output controller 112, and input/output device(s) 114 coupled as shown in FIG. 1.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect.

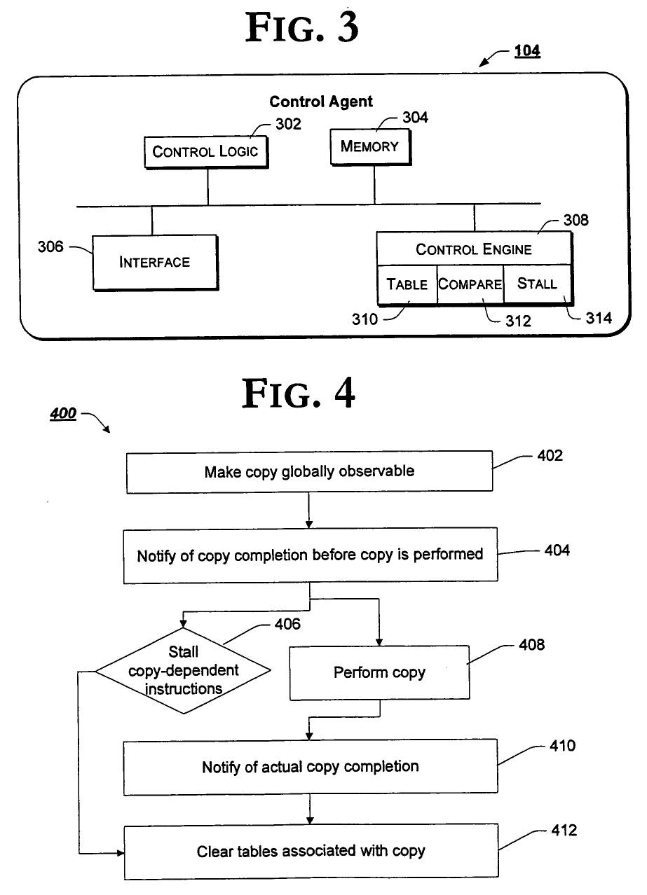

Control agent 104 may have an architecture as described in greater detail with reference to FIG. 3. Control agent 104 may also perform one or more methods for early copy completion, such as the method described in greater detail with reference to FIG. 4. While shown as being part of processor 102, control agent 104 may well be part of another component, or may be implemented in software or a combination of hardware and software.

Memory controller 106 may represent any type control logic that interfaces system memory 110 with the other components of electronic appliance 100. In one embodiment, the connection between processor(s) 102 and memory controller 106 may be referred to as a front-side bus. In another embodiment, memory controller 106 may be referred to as a north bridge. Memory controllers can be integrated with the processor on the same die.

Copy agent 108 may have an architecture as described in greater detail with reference to FIG. 2. Copy agent 108 may also perform one or more methods for early copy completion, such as the method described in greater detail with reference to FIG. 4. While shown as being part of memory controller 106, copy agent 108 may well be part of another component, for example processor(s) 102 or input/output controller 112, or may be implemented in software or a combination of hardware and software.

System memory 110 may represent any type of memory device(s) used to store data and instructions that may have been or will be used by processor(s) 102. Typically, though the invention is not limited in this respect, system memory 110 will consist of dynamic random access memory (DRAM). In one embodiment, system memory 110 may consist of Rambus DRAM (RDRAM). In another embodiment, system memory 110 may consist of double data rate synchronous DRAM (DDRSDRAM). The present invention, however, is not limited to the examples of memory mentioned here.

Input/output (I/O) controller 112 may represent any type of chipset or control logic that interfaces I/O device(s) 114 with the other components of electronic appliance 100. In one embodiment, I/O controller 112 may be referred to as a south bridge. In another embodiment, I/O controller 112 may comply with the Peripheral Component Interconnect (PCI) Express™ Base Specification, Revision 1.0a, PCI Special Interest Group, released Apr. 15, 2003. I/O controller 112 may have internal status registers relating to its operation and the operation of I/O device(s) 114.

Input/output (I/O) device(s) 114 may represent any type of device, peripheral or component that provides input to or processes output from electronic appliance 100. In one embodiment, though the present invention is not so limited, I/O device(s) 114 may include a network interface controller with the capability to perform Direct Memory Access (DMA) operations to copy data into system memory 110. In this respect, there may be a software Transmission Control Protocol/Internet Protocol (TCP/IP) stack being executed by processor(s) 102 that will process the contents in system memory 110 as a result of a DMA by I/O device 114 as TCP/IP packets are received. I/O device(s) 114 in particular, and the present invention in general, are not limited, however, to network interface controllers. In other embodiments, at least one I/O device 114 may be a graphics controller or disk controller, or another controller that may benefit from the teachings of the present invention.

FIG. 2 is a block diagram of an example copy agent architecture, in accordance with one example embodiment of the invention. As shown, copy agent 108 may include one or more of control logic 202, memory 204, interface 206, and copy engine 208 coupled as shown in FIG. 2. In accordance with one aspect of the present invention, to be developed more fully below, copy agent 108 may include a copy engine 208 comprising one or more of notify services 210, copy services 212, and/or complete services 214. It is to be appreciated that, although depicted as a number of disparate functional blocks, one or more of elements 202-214 may well be combined into one or more multi-finctional blocks. Similarly, copy engine 208 may well be practiced with fewer finctional blocks, i.e., with only copy services 212, without deviating from the spirit and scope of the present invention, and may well be implemented in hardware, software, firmware, or any combination thereof. In this regard, copy agent 108 in general, and copy engine 208 in particular, are merely illustrative of one example implementation of one aspect of the present invention. As used herein, copy agent 108 may well be embodied in hardware, software, firmware and/or any combination thereof.

Copy agent 108 may have the ability to receive a copy request, to notify of copy completion before the copy has been performed, and to perform the copy. In one embodiment, copy agent 108 may indicate when the copy has actually been completed. In another embodiment, copy agent 108 may perform copies and notifications without interrupting processor(s) 102, thereby improving performance.

As used herein control logic 202 provides the logical interface between copy agent 108 and its host electronic appliance 100. In this regard, control logic 202 may manage one or more aspects of copy agent 108 to provide a communication interface to electronic appliance 100, e.g., through memory controller 106.

According to one aspect of the present invention, though the claims are not so limited, control logic 202 may selectively invoke the resource(s) of copy engine 208 in response to receiving a command such as, e.g. data copy from processor(s) 102. As part of an example method for early copy completion, as explained in greater detail with reference to FIG. 4, control logic 202 may selectively invoke notify services 210 that may make the details of a copy globally available and notify of completion of the copy before the copy has been performed. Control logic 202 also may selectively invoke copy services 212 or complete services 214, as explained in greater detail with reference to FIG. 4, to perform memory copies or to signal the actual completion of copies, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may be used to store the buffer addresses and lengths of copies that are to be completed, for example.

Interface 206 provides a path through which copy agent 108 can communicate with memory controller 106. In one embodiment, interface 206 may represent any of a wide variety of interfaces or controllers known in the art. In another embodiment, interface 206 may comply with the System Management Bus (SMBus) Specification, Version 2.0, SBS Implementers Forum, released Aug. 3, 2000.

Notify services 210, as introduced above, may provide copy agent 108 with the ability to make the details of a copy globally available and notify of completion of the copy before the copy has been performed. In one example embodiment, notify services 210 may send source and destination buffer addresses, along with their lengths, to processor(s) 102. Control agent 104 may store the address and length in a table as described with reference to FIG. 3. Notify services 210 may then receive an acknowledgement from each control agent 104 that the addresses and lengths have been stored. Notify services 210 may then send a notification of copy completion to the requesting processor 102, even though the copy has not yet been performed.

As introduced above, copy services 212 may provide copy agent 108 with the ability to perform memory copies. In one example embodiment, copy services 212 may copy data from a network controller to system memory 110. In another embodiment, copy services 212 may copy data from system memory 110 to an internal cache of processor(s) 102. The copies may have sources and destinations of other local or remote devices as well.

Complete services 214, as introduced above, may provide copy agent 108 with the ability to signal the actual completion of copies. In one embodiment, complete services 214 may send an indication to processor(s) 102 indicating a buffer address of copies that have completed. Control agent 104 may remove the address from a table of pending copies as described with reference to FIG. 3.

FIG. 3 is a block diagram of an example control agent architecture, in accordance with one example embodiment of the invention. As shown, control agent 104 may include one or more of control logic 302, memory 304, interface 306, and control engine 308 coupled as shown in FIG. 3. In accordance with one aspect of the present invention, to be developed more fully below, control agent 104 may include a control engine 308 comprising one or more of table services 310, compare services 312, and/or stall services 314. It is to be appreciated that, although depicted as a number of disparate functional blocks, one or more of elements 302-314 may well be combined into one or more multi-functional blocks. Similarly, control engine 308 may well be practiced with fewer functional blocks, i.e., with only stall services 314, without deviating from the spirit and scope of the present invention, and may well be implemented in hardware, software, firmware, or any combination thereof. In this regard, control agent 104 in general, and control engine 308 in particular, are merely illustrative of one example implementation of one aspect of the present invention. As used herein, control agent 104 may well be embodied in hardware, software, firmware and/or any combination thereof.

Control agent 104 may have the ability to store a buffer address and length associated with a copy to be completed, to compare an address and length within an instruction to the stored address and length, and to stall the instruction if the addresses overlap. In one embodiment, control agent 104 may maintain a table of pending copies that have not yet completed to determine which instructions should not be allowed to execute. In another embodiment, control agent 104 may clear entries in the table when a notification has been received that the copies have been completed.

As used herein control logic 302 provides the logical interface between copy agent 108 and its host electronic appliance 100. In this regard, control logic 302 may manage one or more aspects of copy agent 108 to provide a communication interface to electronic appliance 100, e.g., through processor(s) 102.

According to one aspect of the present invention, though the claims are not so limited, control logic 302 may selectively invoke the resource(s) of control engine 308. As part of an example method for early copy completion, as explained in greater detail with reference to FIG. 4, control logic 302 may selectively invoke table services 310 that may maintain a table of pending copies. Control logic 302 also may selectively invoke compare services 312 or stall services 314, as explained in greater detail with reference to FIG. 4, to compare addresses within instructions to be executed with addresses stored in the pending copy table or to block the execution of loads and store operations if the address within an instruction matches an address in the pending copy table, respectively. As used herein, control logic 302 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 302 is intended to represent content (e.g., software instructions, etc.), which when executed implements the features of control logic 302 described herein.

Memory 304 is intended to represent any of a wide variety of memory devices and/or systems known in the art. According to one example implementation, though the claims are not so limited, memory 304 may well include volatile and non-volatile memory elements, possibly random access memory (RAM) and/or read only memory (ROM). Memory 304 may be used to store a table of buffer addresses and lengths of pending copies, for example. Memory 304 may also store instructions that are being blocked from executing due to stall services 314.

Interface 306 provides a path through which control agent 104 can communicate with processor 102. In one embodiment, interface 306 may represent any of a wide variety of interfaces or controllers known in the art. In another embodiment, interface 206 may comply with the System Management Bus (SMBus) Specification, Version 2.0, SBS Implementers Forum, released Aug. 3, 2000.

Table services 310, as introduced above, may provide control agent 104 with the ability to maintain a table of pending copies. In one example embodiment, table services 310 receives buffer addresses and lengths for the source and destination of pending copies from copy agent 108. Table services 310 may send an acknowledgement to copy agent 108 whenever an address is added to or removed from the pending copy table stored in memory 304.

As introduced above, compare services 312 may provide control agent 104 with the ability to compare addresses within instructions to be executed with addresses stored in the pending copy table. In one example embodiment, compare services 312 may check the load and store addresses that the CPU generates when executing instructions.

Stall services 314, as introduced above, may provide control agent 104 with the ability to block the execution of load and store operations (and thereby the originating instructions) if the address within an instruction matches an address in the pending copy table. In one embodiment, stall services 314 will allow memory accesses to be retried periodically or after an entry has been removed from the pending copy table. In another embodiment, stall services 314 may provide an indication to processor(s) 102 that a particular instruction includes a memory address that should not be accessed, and processor(s) 102 may then stall the execution of the instruction.

FIG. 4 is a flow chart of an example method for early copy completion, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, method 400 begins when copy agent 108 may make (402) a copy globally observable. In one example embodiment, a DMA request may originate from one of processor(s) 102, for example as part of a TCP/IP software stack or other application. Notify services 210 may send the buffer address and length to each of table services 310, which would store the pending copy in a table in memory 304.

Next, copy agent 108 may notify (404) of copy completion before the copy is performed. In one example embodiment, notify services 210 will send the early copy completion notification after receiving acknowledgements from all processor(s) 102 that they are aware of the pending copy.

Next, stall services 314 may stall (406) copy-dependent instructions. In one embodiment, compare services 312 looks the source and destination addresses of instructions to be executed up in the pending copy table. Stall services 314 may block those instructions where the instruction addresses match or overlap addresses in the pending copy table until the associated copy has been completed.

At the same time, control logic 202 may selectively invoke copy services 212 to perform (408) the copy. In one example embodiment, copy services 212 copies at least a portion of a TCP/IP packet from one location in system memory 110 to another.

Next, copy agent 108 may notify (410) of actual copy completion. In one embodiment, complete services 214 communicates to each of processor(s) 102 that the copy has actually completed.

Next, control agent 104 may clear (412) tables associated with the copy. In one embodiment, table services 310 clears the associated entry from the pending copy table, thereby allowing any instruction that was blocked by stall services 314 as a result of the pending copy to be executed.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Embodiments of the present invention may be used in a variety of applications. Although the present invention is not limited in this respect, the invention disclosed herein may be used in microcontrollers, general-purpose microprocessors, Digital Signal Processors (DSPs), Reduced Instruction-Set Computing (RISC), Complex Instruction-Set Computing (CISC), among other electronic components. However, it should be understood that the scope of the present invention is not limited to these examples.

The present invention includes various operations. The operations of the present invention may be performed by hardware components, or may be embodied in machine-executable content (e.g., instructions), which may be used to cause a general-purpose or special-purpose processor or logic circuits programmed with the instructions to perform the operations. Alternatively, the operations may be performed by a combination of hardware and software. Moreover, although the invention has been described in the context of a computing appliance, those skilled in the art will appreciate that such functionality may well be embodied in any of number of alternate embodiments such as, for example, integrated within a communication appliance (e.g., a cellular telephone).

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
receiving a copy request;
notifying of copy completion before the copy has been performed; and
performing the copy.

2. The method of claim 1, further comprising:
stalling instructions that are dependent upon the copy being completed.

3. The method of claim 2, wherein stalling instructions that are dependent upon the copy being completed comprises:
storing buffer addresses and lengths associated with the copy;
comparing an address and length within an instruction to the stored address and length; and
stalling the instruction if the addresses overlap.

4. The method of claim 3, further comprising:
clearing the buffer address and length after the copy is performed.

5. The method of claim 1, wherein receiving a copy request comprises:
receiving a direct memory access (DMA) request.

6. The method of claim 1, wherein performing the copy comprises:
copying at least a portion of a transmission control protocol/internet protocol (TCP/IP) packet.

7. An electronic appliance, comprising:
a processor;
a memory;
a chipset; and
a copy engine coupled with the processor, the memory and the chipset, the copy engine to receive a copy request, to notify of copy completion before the copy has been performed, and to perform the copy.

8. The electronic appliance of claim 7, further comprising:
a control engine coupled with the processor to stall instructions that are dependent upon the copy being completed.

9. The electronic appliance of claim 8, wherein the control engine to stall instructions comprises:
the control engine to store a buffer address and length associated with the copy, to compare an address and length within an instruction to the stored address and length, and to stall the instruction if the addresses overlap.

10. The electronic appliance of claim 9, further comprising:
the control engine to clear the buffer address and length after the copy is performed.

11. An apparatus, comprising:
a memory interface;
a processor interface; and
control logic coupled with the memory and processor interfaces, the control logic to receive a copy request, to notify of copy completion before the copy has been performed, and to perform the copy.

12. The apparatus of claim 11, further comprising the control logic to indicate when the copy has actually been completed.

13. The apparatus of claim 12, wherein the control logic to perform the copy comprises the control logic to copy at least a portion of a transmission control protocol/internet protocol (TCP/IP) packet.

14. The apparatus of claim 12, wherein the control logic to receive a copy request comprises the control to receive a direct memory access (DMA) request.

15. The apparatus of claim 11, wherein the apparatus comprises a chipset.

16. An apparatus, comprising:
a chipset interface;
a cache interface; and
control logic coupled with the cache and chipset interfaces, the control logic to store a buffer address and length associated with a copy to be completed, to compare an address and length within an instruction to the stored address and length, and to stall the instruction if the addresses overlap.

17. The apparatus of claim 16, further comprising the control logic to receive the buffer address and length associated with a copy to be completed from a copy engine.

18. The apparatus of claim 17, further comprising the control logic to clear the buffer address and length associated with a copy to be completed after the copy has been completed.

19. The apparatus of claim 18, further comprising the control logic to request the copy engine copy data.

20. The apparatus of claim 16, wherein the apparatus comprises a processor.
